(19) United States
(12) Patent Application Publication
(10) Pub. No.: US 2025/0292373 A1
(43) Pub. Date: Sep. 18, 2025

(54) ELECTRONIC DEVICE AND METHOD WITH IMAGE PROCESSING

(71) Applicant: Samsung Electronics Co., Ltd., Suwon-si (KR)

(72) Inventors: Yasi WANG, Beijing (CN); Lu XU, Beijing (CN); Chao ZHANG, Beijing (CN); Hyong Euk LEE, Suwon-si (KR); Qiang WANG, Beijing (CN); Wooshik KIM, Suwon-si (KR)

(73) Assignee: Samsung Electronics Co., Ltd., Suwon-si (KR)

(21) Appl. No.: 19/081,500

(22) Filed: Mar. 17, 2025

(30) Foreign Application Priority Data
Mar. 15, 2024 (CN) 202410303293.4
Oct. 15, 2024 (KR) 10-2024-0140172

(51) Int. Cl. G06T 5/60; G06T 5/50

(52) U.S. Cl. CPC G06T 5/60; G06T 5/50; G06T 2207/20081; G06T 2207/20084

(57) ABSTRACT

An electronic device includes one or more processors configured to collect an original image for a target scene, and generate a corrected modified image by reflecting a predicted lighting condition of the original image in response to inputting the original image to a first artificial intelligence (AI) model, wherein the first AI model is generated based on a second AI model trained based on any one or any combination of any two or more of a sample image collected under a plurality of lighting conditions, a first actual image comprising a lighting condition of the sample image, and a second actual image comprising color information of an object in the sample image.

### CROSS-REFERENCE TO RELATED APPLICATIONS

This application claims the benefit under 35 USC § 119(a) of Chinese Patent Application No. 202410303293.4 filed on Mar. 15, 2024 in the China National Intellectual Property Administration, and Korean Patent Application No. 10-2024-0140172, filed on Oct. 15, 2024 in the Korean Intellectual Property Office, the entire disclosures of which are incorporated herein by reference for all purposes.

### BACKGROUND

### 1. Field

The following description relates to an electronic device and method with image processing.

### 2. Description of Related Art

Color constancy may be a characteristic of a vision system of humans and may refer to a perception attribute that a color of an object perceived by a person remains the same even if the color of an object surface changes depending on a lighting condition. For example, charcoal may always be perceived as black in the dark or under sunlight. A deep learning-based neural network may restore a color by predicting the color constancy of an object under an arbitrary lighting condition.

However, when predicting the color constancy of an arbitrary lighting object using the deep learning-based neural network and restoring the color, in the case of an extreme lighting change, prediction performance degradation may persist, and real-time processing may be limited when significant computation resources are required to implement a high-performance model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors configured to collect an original image for a target scene, and generate a corrected modified image by reflecting a predicted lighting condition of the original image in response to inputting the original image to a first artificial intelligence (AI) model, wherein the first AI model is generated based on a second AI model trained based on any one or any combination of any two or more of a sample image collected under a plurality of lighting conditions, a first actual image comprising a lighting condition of the sample image, and a second actual image comprising color information of an object in the sample image.

The second AI model may be trained by generating, using the second AI model, a first predicted image comprising the lighting condition information of the sample image and a second predicted image comprising the color information of the object in the sample image through image processing on the sample image, determining a target loss value by comparing the first predicted image with the first actual image and comparing the second predicted image with the second actual image, and training the second AI module by adjusting a parameter of the second AI model based on the determined target loss value, and the first AI model may be the trained second AI model.

The first actual image may include either one or both of a first image in which the lighting condition information of the sample image is visually represented and a second image in which an original color of an object is restored by removing a color bias according to the lighting condition information of the sample image.

The second actual image may include a third image generated using either one of the second image and a reflectance image generated through color space conversion of the sample image and the first image, wherein the third image characterizes color similarity between pixels of the sample image, and a fourth image that characterizes a plane direction of the object in the sample image.

The third image may be generated based on a first color similarity between color information of first pixels uniformly selected from one reference image of the reflectance image and the second image and color information of second pixels other than the first pixels in the reference image and second color similarity between color information of third pixels fixed to an object in the reference image and fourth pixels other than the third pixels in the reference image.

The fourth image may be generated through a third AI model that is pre-trained to output a normal vector by receiving one reference image of the second image and a multi-color component image generated by converting the reflectance image.

In one or more general aspects, a processor-implemented method includes receiving an original image for a target scene, and generating a modified image in which a prediction result of lighting condition information of the original image is reflected, in response to inputting the original image to a first artificial intelligence (AI) model, wherein the first AI model is generated based on a second AI model trained based on any one or any combination of any two or more of a sample image collected under a plurality of pieces of lighting condition information, a first actual image comprising lighting condition information of the sample image, and a second actual image comprising color information of an object in the sample image.

The second AI model may be trained by generating, using the second AI model, a first predicted image comprising the lighting condition information of the sample image and a second predicted image comprising the color information of the object in the sample image through image processing on the sample image, determining a target loss value by comparing the first predicted image with the first actual image and comparing the second predicted image with the second actual image, and training the second AI module by adjusting a parameter of the second AI model based on the determined target loss value, and the first AI model may be the trained second AI model.

The first actual image may include either one or both of a first image in which the lighting condition information of the sample image is visually represented and a second image in which an original color of an object is restored by removing a color bias according to the lighting condition information of the sample image.

The second actual image may include a third image generated using either one of the second image and a reflectance image generated through color space conversion of the sample image and the first image, wherein the third image characterizes color similarity between pixels of the sample image, and a fourth image that characterizes a plane direction of the object in the sample image.

The third image may be generated based on a first color similarity between color information of first pixels uniformly selected from one reference image of the reflectance image and the second image and color information of second pixels other than the first pixels in the reference image and second color similarity between color information of third pixels fixed to an object in the reference image and fourth pixels other than the third pixels in the reference image.

The fourth image may be generated through a third AI model that is pre-trained to output a normal vector by receiving one reference image of the second image and a multi-color component image generated by converting the reflectance image.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes generating a first predicted image comprising lighting condition information of a sample image and a second predicted image comprising color information of an object in the sample image, in response to inputting the sample image comprised in training data to a second artificial intelligence (AI) model, determining a target loss value by comparing the first predicted image with a first actual image and comparing the second predicted image with a second actual image comprised in the training data, adjusting a parameter of the second AI model by training the parameter of the second AI model based on the determined target loss value, and generating a first AI model for outputting a corrected modified image by reflecting a predicted lighting condition of an original image based on the second AI model of which the parameter is adjusted.

The first actual image may include either one or both of a first image in which the lighting condition information of the sample image is visually represented and a second image in which an original color of an object is restored by removing a color bias according to the lighting condition information of the sample image.

The second actual image may include a third image generated using either one of the second image and a reflectance image generated through color space conversion of the sample image and the first image, wherein the third image characterizes color similarity between pixels of the sample image, and a fourth image that characterizes a plane direction of the object in the sample image.

The reflectance image may be generated by performing lighting information from a first XYZ image generated by performing color space conversion on the sample image, based on a second XYZ image generated by performing color space conversion on the first image.

The reflectance image may be generated by, in response to the sample image being a multi-lighting image captured under a multi-lighting condition, generating a third XYZ image by performing color space conversion on a single lighting image captured under a single lighting condition for a same scene as the multi-lighting image, generating a fourth XYZ image by performing color space conversion on a first image corresponding to the single lighting image, determining XYZ reflectance for the single lighting image by removing lighting information from the third XYZ image based on the fourth XYZ image, and aggregating and normalizing XYZ reflectances for single lighting images according to the multi-lighting condition to generate the reflectance image.

The third image may be generated based on a first color similarity between color information of first pixels uniformly selected from one reference image of the reflectance image and the second image and color information of remaining pixels other than the first pixels in the reference image and second color similarity between color information of second pixels fixed to an object in the reference image and remaining pixels other than the second pixels in the reference image.

The fourth image may be generated through a third AI model that is pre-trained to output a normal vector by receiving one reference image of the second image and a multi-color component image generated by converting the reflectance image.

Other features and aspects will be apparent from the following detailed description, the drawings, and the claims.

### BRIEF DESCRIPTION OF THE DRAWINGS

FIG. 1 is a diagram illustrating an electronic device that performs image processing based on a prediction of a lighting condition according to one or more embodiments.

FIG. 2 is an example of a coupling effect of lighting and reflectance according to one or more embodiments.

FIG. 3 is a flowchart illustrating an image processing method using a first artificial intelligence (AI) model according to one or more embodiments.

FIG. 4 is a flowchart illustrating a training method of a second AI model according to one or more embodiments.

FIG. 5 is a diagram illustrating a method of obtaining a first predicted image through a lighting condition prediction task according to one or more embodiments.

FIG. 6 is a diagram illustrating a network structure for extracting a secondary feature of a sample image according to one or more embodiments.

FIG. 7 is a flowchart illustrating a method of generating a reflectance image used to generate an actual color similarity image of a second actual image according to one or more embodiments.

FIG. 8 is a flowchart illustrating a method of generating a reflectance image when a sample image is a multi-light image according to one or more embodiments.

FIG. 9 is a flowchart illustrating a method of generating an actual color similarity image using a reflectance image according to one or more embodiments.

FIG. 10 is a diagram illustrating a determination result of color similarity according to one or more embodiments.

FIG. 11 is a diagram illustrating a method of generating an actual normal vector image of a second actual image according to one or more embodiments.

FIG. 12 is a diagram illustrating a result of performing gamma correction according to one or more embodiments.

FIG. 13 is a diagram illustrating an experimental result according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, embodiments will be described in detail with reference to the accompanying drawings. When describing the embodiments with reference to the accompanying drawings, like reference numerals refer to like elements and a repeated description related thereto will be omitted.

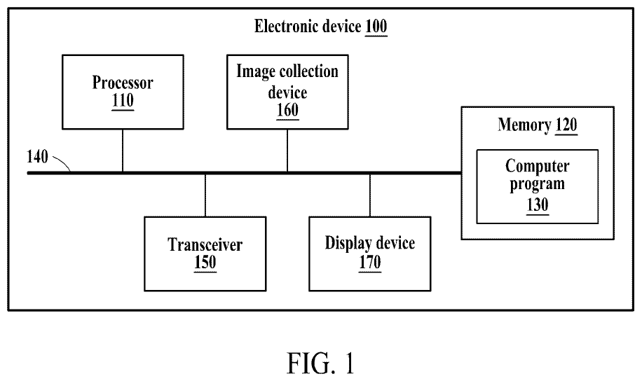

FIG. 1 is a diagram illustrating an electronic device that performs image processing based on a prediction of a lighting condition according to one or more embodiments.

Referring to FIG. 1, an electronic device 100 may include a processor 110 (e.g., one or more processors, a memory 120 (e.g., one or more memories) configured to load or store a computer program 130 executed by the processor 110, an image collection device 160, and a display device 170. The processor 110 and the memory 120 may be connected to each other via a communication link 140 (e.g., a bus). Optionally, the electronic device 100 may further include a transceiver 150 and the transceiver 150 may be used for data exchange, such as transmission and/or reception of data between the electronic device 100 and another electronic device. The components included in the electronic device 100 of FIG. 1 are just an example, and one of ordinary skill in the art may understand that general components other than the components shown in FIG. 1 may be further included.

The processor 110 may control the overall operation of each component of the electronic device 100. The one or more processors 110 may include at least one of a central processing unit (CPU), a microprocessor unit (MPU), a microcontroller unit (MCU), a graphics processing unit (GPU), a neural processing unit (NPU), a digital signal processor (DSP), and other well-known types of processors in a relevant technical field of the present disclosure. In addition, the processor 110 may perform an operation on the computer program 130 or at least one application to execute a method and/or an operation according to various embodiments of the present disclosure. The computing device 100 may include one or more processors.

The memory 120 may store one or a combination of two or more of various pieces of data, commands, or information used by a component (e.g., the processor 110) included in the electronic device 100. The memory 120 may include volatile memory and/or non-volatile memory.

The computer program 130 may include one or more actions through which the methods/operations described herein according to embodiments are implemented and may be stored in the memory 120 as software. In this case, the action may correspond to a command that is implemented in the program 130. For example, the program 130 may include commands to execute an operation of receiving an original image for a target scene and an operation of obtaining a modified image in which a prediction result of light condition information of the original image is reflected in response to inputting the original image to a first artificial intelligence (AI) model.

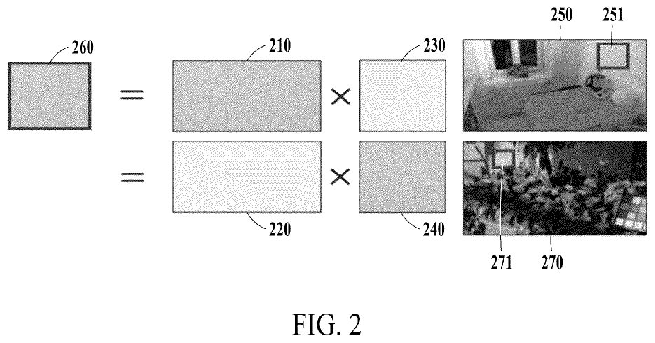

When the computer program 130 is loaded to the memory 120, the processor 110 may execute various methods and/or operations according to various embodiments of the present disclosure by executing a plurality of operations to implement the program 130. For example, the memory 120 may include a non-transitory computer-readable storage medium storing instructions that, when executed by the processor 110, configure the processor 110 to perform any one, any combination, or all of operations and/or methods disclosed herein with references to FIGS. 2-13.

The communication link 140 may include a path to transmit various pieces of data, commands, and information among components included in the electronic device 100. The communication link 140 may be, for example, a peripheral component interconnect (PCI) bus or an extended industry standard architecture (EISA) bus. However, the type of the bus is an example and is not limited thereto. For example, a bus is illustrated by a single line for ease of description in FIG. 1, but a plurality of buses or various types of buses may be included.

The image collection device 160 may include one or more cameras including one or more image sensors. The image collection device 160 may capture or generate an image or video (e.g., the original image). The image collection device 160 may include a device for collecting various spectral images, such as visible light, infrared rays, and ultraviolet rays, and the type of spectral images collected by the device is an example and is not limited thereto.

The display device 170 may provide an output of the electronic device 100 to a user through a visual and/or haptic channel. The display device 170 may include, for example, a visual display, a touch screen, and/or any other device that provides the output to the user. For example, the display device 170 may visually display an image or video (e.g., the modified image) to the user.

FIG. 2 is an example of a coupling effect of lighting and reflectance according to one or more embodiments.

An image observation may be determined by a combination of two main factors, which are lighting and reflectance. In this case, lighting may be a color of light and reflectance may be a unique color of an object. In an example of FIG. 2, yellow lighting 210 and white lighting 220 may be used and reflectance 230 of a white wall and reflectance 240 of a yellow wall 240 may be used.

Referring to FIG. 2, even though a first area 251 of an upper image 250 has the reflectance 230 of the white wall, the first area 251 may appear in yellow 260 by the yellow lighting 210. On the other hand, even though a second area 271 of a lower image 270 having the reflectance 240 of the yellow wall is the white lighting 220, the lower image 270 may still appear in yellow 260.

As described above, although the first area 251 and the second area 271 are walls having different reflectances, both the first area 251 and the second area 271 may appear in yellow 260 by a combination of lighting, and such a vague and/or inconsistent relationship between the lighting and the reflectance may hinder a typical deep learning-based neural network to learn and process color constancy.

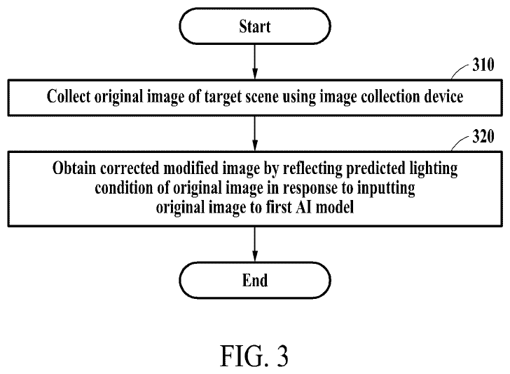

FIG. 3 is a flowchart illustrating an image processing method using a first artificial intelligence (AI) model according to one or more embodiments. In one or more embodiments, at least two of operations of FIG. 3 may be simultaneously or parallelly performed, the order of the operations may be changed, at least one of the operations may be omitted, and/or one or more other operations may be additionally performed without departing from the spirit and scope of the example embodiments described herein. The operations shown in FIG. 3 may be performed by at least one component of an electronic device (e.g., the electronic device 100 of FIG. 1).

In operation 310, a processor (e.g., the processor 110 of FIG. 1) of the electronic device may collect an original image for a target scene using an image collection device (e.g., the image collection device 160 of FIG. 1). In one or more embodiments, the processor may collect the original image for the target scene using the image collection device (e.g., a camera module of a mobile phone) built into the electronic device. In this case, the image collection device may include a device for collecting various spectral images, such as visible light, infrared rays, and ultraviolet rays, and the type of spectral images collected by the device is an example and is not limited thereto.

In one or more embodiments, the processor may collect the original image for the target scene using an independent image collection device disposed outside of the electronic device. For example, when the image collection image (e.g., a multispectral camera or a Doppler camera) for collecting a multispectral image and special information is not included in the electronic device, the processor may collect the multispectral image for the target scene as the original image using the image collection device disposed outside of the electronic device. In this case, the electronic device and the image collection device disposed outside may be connected to each other wirelessly or by wire and the processor may collect the original image from the image collection device through a transceiver (e.g., the transceiver 150 of FIG. 1) of the electronic device.

In operation 320, the processor may obtain a modified image in which the original image is corrected by reflecting a predicted lighting condition of the original image in response to inputting the original image to a first AI model. According to one or more embodiments, the first AI model may predict a lighting condition of the original image by receiving the original image as an input and may generate a modified image in which color distortion of the original image is corrected to maintain color constancy based on a prediction result. For example, when a specific pixel of the original image is displayed on a display device (e.g., the display device 170 of FIG. 1) while being distorted from its original color due to various lighting conditions, the first AI model may restore the color of the pixel to the original color based on a predicted lighting condition from the original image. Through this, the electronic device of one or more embodiments may minimize color distortion of an object under various conditions and may allow consistent color representation on the display device.

In one or more embodiments, the first AI model may be obtained (e.g., generated) by training a second AI model using training data collected under a preset lighting condition. The training data may include a sample image collected for an object under a plurality of lighting conditions, a first actual image, and a second actual image with respect to the sample image.

The sample image may include an image obtained under single-lighting and/or multi-lighting conditions. The obtained sample image may include an object related to the target scene. The processor may collect the sample image for various scenes to increase a volume of training data. For example, the processor may collect a sample image that captures various objects, a sample image captured in various time zones, and a sample image captured using light sources at various angles. However, the method of obtaining the sample image described above is an example and is not limited thereto.

The first actual image and the second actual image may be used as reference data corresponding to ground truth (GT) in a training process of the second AI model. In this case, the first actual image may be used as the reference data in a prediction process of a lighting condition during the training process of the second AI model and the second actual image may be used as the reference data in a prediction process of color information of an object.

The first actual image may include information about a lighting condition of a sample image. For example, the first actual image may include a first image including lighting information, such as an intensity, a direction, and/or a shadow of lighting by visually representing a lighting state reflected on a surface of the object. For example, the first image may be a light map. The light map may be generated by performing image processing based on the sample image and may include information about a lighting effect reflected on or received by the object surface in the scene or texture mapped onto the object surface. However, the type of the first image described above is an example and is not limited thereto.

Alternatively or additionally, the first actual image may include a second image including original color information of the object. For example, the second image may be a white balance corrected image from which a color bias due to lighting is removed. A white-removed balance corrected image may be generated by performing image processing based on the sample image or may be obtained using a white balance function of the image collection device for the same scene as the sample image. However, the type of the second image described above is an example and is not limited thereto.

The second actual image may include information about an object color in the sample image. For example, the second actual image may include a third image that characterizes similarity between pixels of the sample image. For example, the third image may be an actual color similarity image. However, the type of the third image is an example and is not limited thereto.

Alternatively or additionally, the second actual image may include a fourth image that characterizes a plane direction of the object in the sample image. For example, the fourth image may be a normal vector actual image, but the type of the fourth image described above is an example and is not limited thereto.

Examples of the training method of the second AI model using the training data is further described with reference to the following drawings.

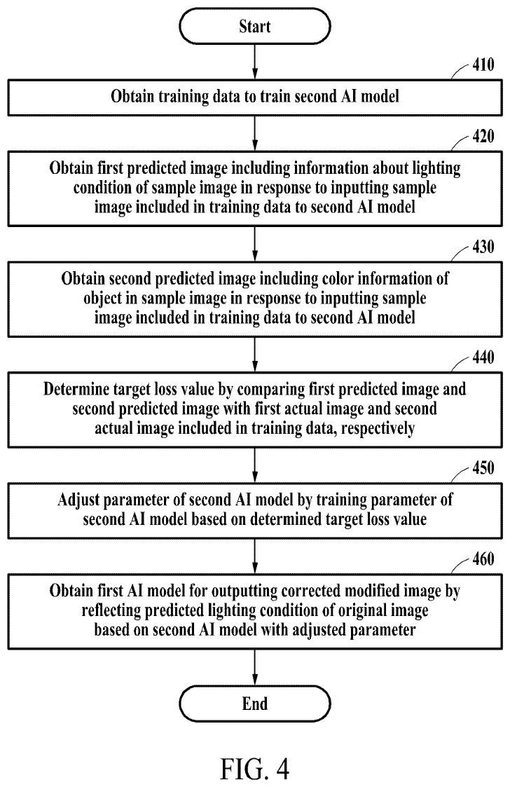

FIG. 4 is a flowchart illustrating a training method of a second AI model according to one or more embodiments. In one or more embodiments, at least two of operations of FIG. 4 may be simultaneously or parallelly performed, the order of the operations may be changed, at least one of the operations may be omitted, and/or one or more other operations may be additionally performed without departing from the spirit and scope of the example embodiments described herein. The operations shown in FIG. 4 may be performed by at least one component of an electronic device (e.g., the electronic device 100 of FIG. 1).

In operation 410, a processor (e.g., the processor 110 of FIG. 1) of the electronic device may obtain training data to train the second AI model. The training data may include a sample image collected for an object under a plurality of lighting conditions, a first actual image, and a second actual image with respect to the sample image.

In operation 420, the processor may obtain a first predicted image including information about a lighting condition of a sample image in response to inputting the sample image included in the training data to the second AI model. According to one or more embodiments, the second AI model may extract a feature from the sample image and may obtain (e.g., generate) the first predicted image by predicting the lighting condition of the sample image based on the extracted feature.

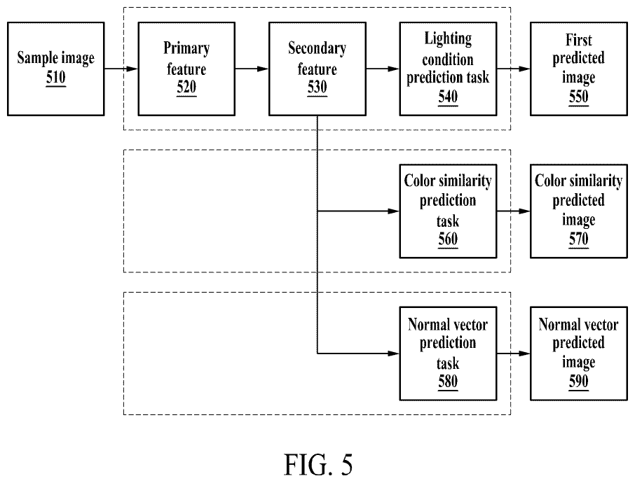

Referring to FIG. 5, to describe an example method of obtaining the first predicted image through a lighting condition prediction task of operation 420, the second AI model may extract a primary feature 520 with respect to an input sample image 510. For example, the second AI model may extract basic visual information, such as a color, texture, an edge, and a corner, as the primary feature 520 of the sample image 510 by analyzing the image at a pixel level. The primary feature 520 may have high details since the primary feature 520 includes detailed information as the primary feature 520 is extracted at the pixel level. The primary feature 520 may be represented by low-dimensional data.

The second AI model may extract abstract visual information as a secondary feature 530 of the sample image 510 by analyzing the sample image 510 as a whole based on the extracted primary feature 520. The secondary feature 530 may have relatively rough details compared to the primary feature 520 and may be represented by high-dimensional data.

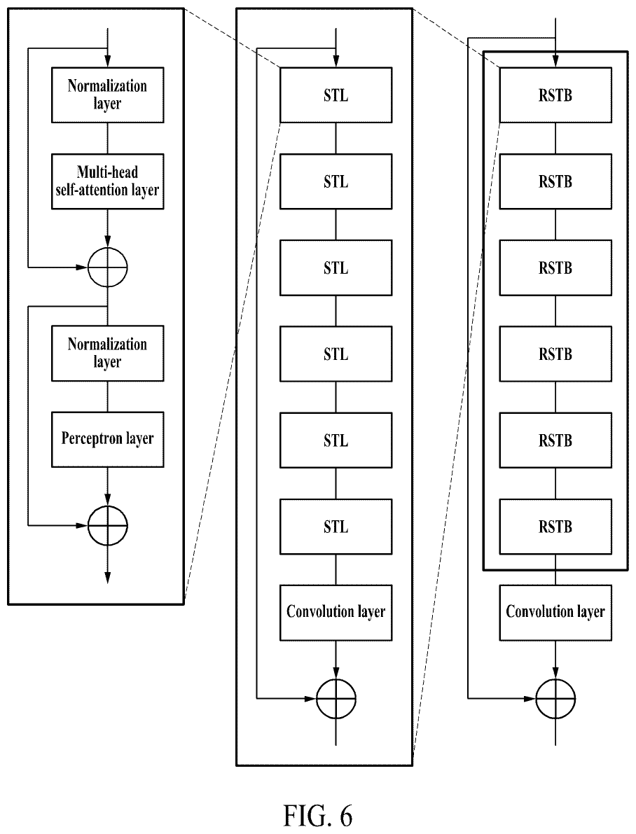

The second AI model may generate a first predicted image 550 by performing a lighting condition prediction task 540 based on the extracted secondary feature 530. According to one or more embodiments, the second AI model may perform the lighting condition prediction task 540 using a swin image restoration (SwinIR) network structure for performing image restoration. In this case, the second AI model may use the SwinIR network structure to extract the secondary feature 530 of the sample image 510 as shown in FIG. 6, as an example.

Referring to FIG. 6, the SwinIR network structure may include a plurality of sequentially connected residual swin transformer block (RSTB) layers and convolutional layers, which are output layers. In this case, each RSTB layer may include a plurality of sequentially connected swin transformer layers (STLs) and convolutional layers, which are output layers. Each STL layer may include a normalization layer, a multi-head self-attention layer, and a perceptron layer.

Referring back to FIG. 4, in operation 430, the processor may obtain a second predicted image including color information of the object in the sample image in response to inputting the sample image included in the training data to the second AI model. According to one or more embodiments, the second AI model may obtain at least one second predicted image of a color similarity predicted image and a normal vector-predicted image, based on the feature extracted from the sample image.

By considering that pixels of the sample image of the same scene may be displayed in different colors due to different lighting conditions, the processor may provide a method of maintaining color constancy by additionally performing two auxiliary tasks. The first auxiliary task may output the color similarity predicted image by performing surface color similarity prediction. The first auxiliary task may capture a color distribution of the scene by identifying what area of the scene has a similar color by learning the color similarity between surface pixels.

The second auxiliary task may output the normal vector-predicted image by performing surface normal vector prediction. The second auxiliary task may capture a plane distribution in the scene by learning a surface normal vector with respect to different plane directions in the scene. For example, planes oriented in different directions in the scene may receive different lightings but planes oriented in the same direction may receive similar lighting.

Referring to FIG. 5, to describe an example method of obtaining the second predicted image through the auxiliary task of operation 430, the second AI model may generate a color similarity predicted image 570 by performing a surface color similarity prediction task 560 based on the secondary feature 530 extracted during the process of obtaining the first predicted image. According to one or more embodiments, the second AI model may perform the color similarity prediction task 560 using an auxiliary network structure including a plurality of convolutional layers and activation layers. For example, the auxiliary network structure may be a structure in which five convolutional layers and five activation layers (e.g., rectified linear unit (ReLU) layers and Sigmoid layers) are alternately disposed. However, the auxiliary network structure described above is an example and is not limited thereto.

Alternatively or additionally, to describe an example method of obtaining the second predicted image through the auxiliary task of operation 430, the second AI model may generate a normal vector-predicted image 590 by performing a surface normal vector prediction task 580 based on the secondary feature 530. According to one or more embodiments, the second AI model may generate the normal vector-predicted image 590 through the auxiliary network structure used when performing the color similarity prediction task 560.

Referring back to FIG. 4, in operation 440, the processor may determine a target loss value by comparing the first predicted image (e.g., the first predicted image 550) with the first actual image included in the training data and comparing the second predicted image (e.g., the color similarity predicted image 570 and/or the normal vector-predicted image 590) with the second actual image included in the training data. For example, the processor may determine a target loss value by comparing the first predicted image 550 with the first actual image included in the training data and comparing either one or both of the color similarity predicted image 570 with the actual color similarity image and/or the normal vector-predicted image 590 with the actual normal vector image.

According to one or more embodiments, the processor may determine a first loss value between the first predicted image and the actual image (e.g., the first actual image) based on a preset mean square angular error (MSAE) L_{AE} loss function.

According to one or more embodiments, the processor may determine a second loss value between the color similarity predicted image (e.g., the second predicted image) and the actual color similarity image (e.g., the second actual image) based on a preset L₁ (mean absolute error (MAE)) loss function.

According to one or more embodiments, the processor may determine a third loss value between the normal vector-predicted image (e.g., the second predicted image) and the actual normal vector image (e.g., the second actual image) based on the preset L₁ loss function.

The processor may determine the target loss value Lₜₒₜₐₗ using a loss function based on the determined first loss value and either one or both of the second loss value and the third loss value. For example, the processor may determine the target loss value Lₜₒₜₐₗ using a loss function as Equation 1 below based on the determined first loss value, the second loss value, and the third loss value.

$${L}_{total} = {λ}_{AE} {L}_{AE} ( {Illum}_{pred} , {Illum}_{gt} ) + {λ}_{SM} {L}_{1} ( S {M}_{pred} , {SM}_{gt} ) + {λ}_{SN} {L}_{1} ( S {N}_{pred} , {SN}_{gt} ) \qquad Equation l$$

In this case, Illum_{pred} and Illum_{gt} may respectively denote the first predicted image and the first actual image, SM_{pred}, SM_{gt}, SN_{pred}, and SN_{gt} may respectively denote the color similarity predicted image, the actual color similarity image, the normal vector-predicted image, and the actual normal vector image, and λ_{AE}, λ_{SM}, and λ_{SN} may respectively denote weights corresponding to the first loss value, the second loss values, and the third loss value.

In operation 450, the processor may adjust a parameter of the second AI model by training the parameter of the second AI model based on the determined target loss value.

In operation 460, the processor may obtain the first AI model for outputting a corrected modified image by reflecting a predicted lighting condition of the original image based on the second AI model with the adjusted parameter.

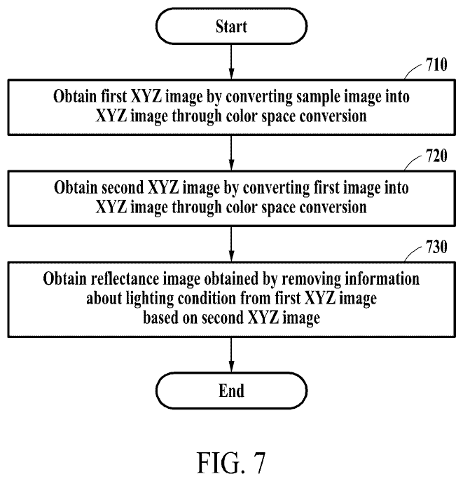

FIG. 7 is a flowchart illustrating a method of generating a reflectance image used to generate an actual color similarity image of a second actual image according to one or more embodiments. In one or more embodiments, at least two of operations of FIG. 7 may be simultaneously or parallelly performed, the order of the operations may be changed, at least one of the operations may be omitted, and/or one or more other operations may be additionally performed without departing from the spirit and scope of the example embodiments described herein. The operations shown in FIG. 7 may be performed by at least one component of an electronic device (e.g., the electronic device 100 of FIG. 1).

According to one or more embodiments, when a first actual image includes a first image (e.g., a light map) that characterizes information about a lighting condition (e.g., single lighting) of a sample image, in operation 710, a processor (e.g., the processor 110 of FIG. 1) of the electronic device may obtain a first XYZ image by converting the sample image into an XYZ image through XYZ color space conversion. For example, the sample image may be an image represented in a red, green, and blue (RGB) color space and for some pixels, color distortion may occur depending on the lighting condition. The processor may perform XYZ color space conversion (for example, may convert the sample image into the XYZ color space, which is a color space independent of the lighting condition) through a color correction matrix (CCM) to remove the color distortion.

In operation 720, the processor may obtain a second XYZ image by converting the first image into an XYZ image through XYZ color space conversion. For example, the first image may be a light map and may be an image that visually represents the information about a light condition collected from the sample image. The processor may perform the XYZ color space conversion on the first image, for example, may obtain a second XYZ image in which the information about the lighting condition is represented through a color mapping function (CMF).

In operation 730, the processor may obtain a reflectance image obtained by removing the information about the lighting condition from the first XYZ image based on the second XYZ image. For example, the reflectance image may be determined by dividing the first XYZ image by the second XYZ image.

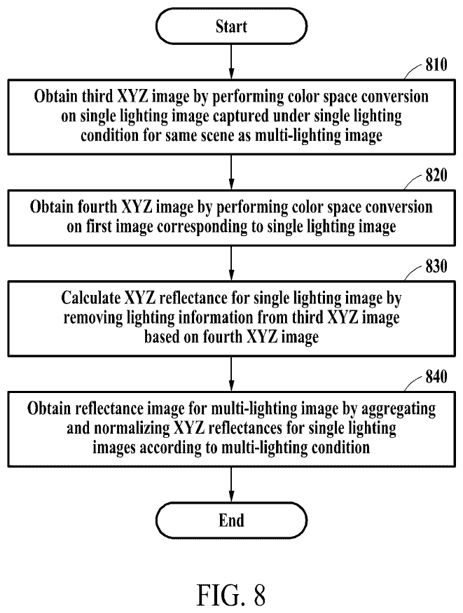

FIG. 8 is a flowchart illustrating a method of generating a reflectance image when a sample image is a multi-light image according to one or more embodiments. In one or more embodiments, at least two of operations of FIG. 8 may be simultaneously or parallelly performed, the order of the operations may be changed, at least one of the operations may be omitted, and/or one or more other operations may be additionally performed without departing from the spirit and scope of the example embodiments described herein. The operations shown in FIG. 8 may be performed by at least one component of an electronic device (e.g., the electronic device 100 of FIG. 1).

In operation 810, the processor may obtain a third XYZ image by performing color space conversion on a single-lighting image captured under a single lighting condition for the same scene as a multi-lighting image. For example, the processor may convert the single-lighting image into the XYZ color space, which is a color space independent of the lighting condition, through the CCM.

In operation 820, the processor may obtain a fourth XYZ image by performing color space conversion on the first image corresponding to the single lighting image. For example, the processor may convert the first image into the XYZ color space through a CMF.

In operation 830, the processor may determine XYZ reflectance for the single lighting image by removing the lighting information from the third XYZ image based on the fourth XYZ image.

In operation 840, the processor may obtain a reflectance image for the multi-lighting image by aggregating and normalizing XYZ reflectances for single-lighting images according to a multi-lighting condition. For example, the processor may perform operations 810, 820, and 830 for each of a plurality of single-lighting images to determine a plurality of XYZ reflectances respectively for the single-lighting images, and then, in operation 840, the processor may obtain a reflectance image for the multi-lighting image by aggregating and normalizing XYZ reflectances for the single-lighting images according to a multi-lighting condition.

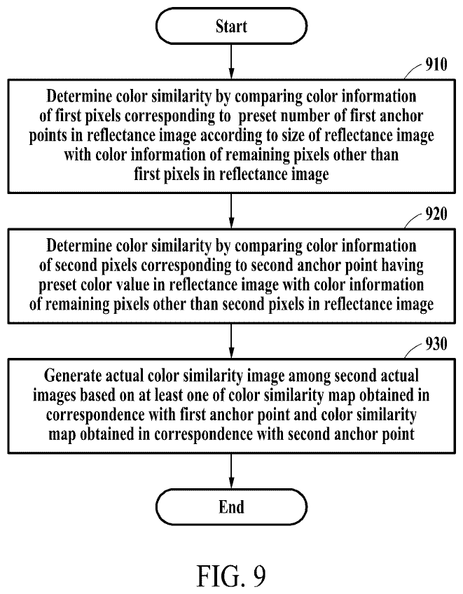

FIG. 9 is a flowchart illustrating a method of generating an actual color similarity image using a reflectance image according to one or more embodiments. In one or more embodiments, at least two of the operations of FIG. 9 may be simultaneously or parallelly performed, the order of the operations may be changed, at least one of the operations may be omitted, and/or one or more other operations may be additionally performed without departing from the spirit and scope of the example embodiments described herein. The operations shown in FIG. 9 may be performed by at least one component of an electronic device (e.g., the electronic device 100 of FIG. 1).

In operation 910, the processor may determine color similarity by comparing color information of first pixels corresponding to a preset number of first anchor points in a reflectance image according to the size of the reflectance image with color information of remaining pixels other than the first pixels in the reflectance image. In this case, the first pixels of the first anchor point may evaluate the color similarity in various positions in the reflectance image since the first pixels are uniformly distributed at predetermined intervals in the reflectance image.

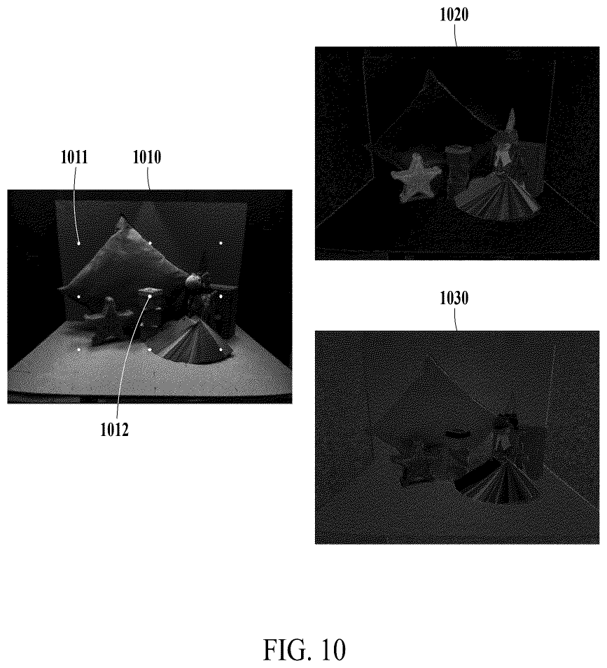

According to one or more embodiments, the processor may select nine first anchor points uniformly distributed in different positions in a reflectance image 1010 as shown in FIG. 10. While an example shows nine first anchor points, this is only an example, and the number of first anchor points may be less than or greater than nine according to other examples. For each of the first anchor points, the processor may obtain a color similarity map (e.g., a light map) representing color similarity for the first anchor point by determining similarity between the color information of the first pixel corresponding to the first anchor point and the remaining pixels other than the first pixels. In each of color similarity maps 1020 and 130, a darker area in the color similarity map may indicate a greater similarity to the corresponding first anchor point.

For example, the processor may obtain a color similarity map 1020 representing color similarity for a yellow anchor point 1011 among nine first anchor points uniformly distributed in the reflectance image 1010 of FIG. 10. Since the yellow anchor point 1011 is positioned on a background plate having a more similar color to the yellow anchor point 1011 than other areas in the color similarity map 1020, a color of a background plate area is darker than the other areas in the color similarity map 1020.

As another example, the processor may obtain a color similarity map 1030 representing color similarity for a green anchor point 1012 among the nine first anchor points uniformly distributed in the reflectance image 1010 of FIG. 10. Since the green anchor point 1012 is positioned in a box having a more similar color to the green anchor point 1012 than other areas in the color similarity map 1020, a color of a box area is darker than the other areas in the color similarity map 1030.

As described above, the processor may obtain nine final color similarity maps for the first anchor points by obtaining color similarities for the remaining seven first anchor points in the same manner.

In operation 920, the processor may determine the color similarity by comparing color information of second pixels corresponding to a second anchor point having a preset color value in the reflectance image with color information of the remaining pixels other than the second pixels in the reflectance image. In this case, the second pixels of the second anchor point may be set based on a color of a specific object in the reflectance image. For example, the second anchor point may have a fixed color value, such as (0,255,255), (255,0,255), and (255,255,0). The color value and the number of second anchor points may be adjusted according to actual needs.

According to one or more embodiments, for each of the second anchor points that are set in correspondence with the specific object of the reflectance image, the processor may obtain a color similarity map representing the color similarity for the second anchor point by determining the similarity between the color information of the second pixels corresponding to the second anchor point and the remaining pixels other than the second pixel.

In operation 930, the processor may generate an actual color similarity image of the second actual image based on at least one of the color similarity map obtained in correspondence with the first anchor point and the color similarity map obtained in correspondence with the second anchor point. The generated actual color similarity image may be used as reference data corresponding to GT in the training process of the second AI model.

In addition, when the first actual image includes a second image (e.g., a white balance corrected image), the processor may also generate the actual color similarity image of the second actual image by performing operations 910 to 930 using the second image without the color space conversion process.

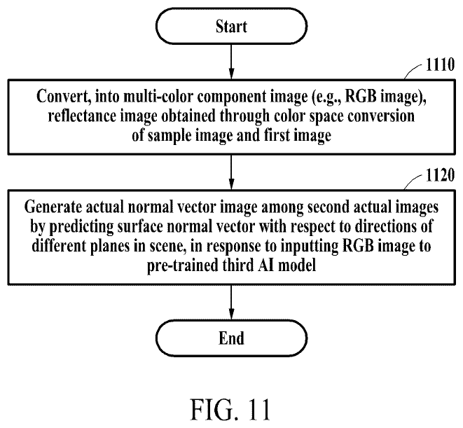

FIG. 11 is a diagram illustrating a method of generating an actual normal vector image of a second actual image according to one or more embodiments. In one or more embodiments, at least two of operations of FIG. 11 may be simultaneously or parallelly performed, the order of the operations may be changed, at least one of the operations may be omitted, and/or one or more other operations may be additionally performed without departing from the spirit and scope of the example embodiments described herein. The operations shown in FIG. 11 may be performed by at least one component of an electronic device (e.g., the electronic device 100 of FIG. 1).

According to one or more embodiments, when a first actual image includes a first image (e.g., a light map) that characterizes information about a lighting condition of a sample image, in operation 1110, a processor (e.g., the processor 110 of FIG. 1) of the electronic device may convert a reflectance image obtained through color space conversion of the sample image and the first image into a multi-color component image (e.g., an RGB image).

In operation 1120, in response to inputting an RGB image to a pre-trained third AI model, the processor may generate an actual normal vector image among second actual image by predicting a surface normal vector with respect to directions of different planes in a scene. The generated actual normal vector image may be used as reference data corresponding to GT in the training process of the second AI model.

In addition, when the first actual image includes a second image (e.g., a white balance corrected image) that characterizes the original color information of an object, the processor may generate the actual normal vector image of the second actual image by predicting a surface normal vector with respect to directions of different planes in the scene in response to inputting the second image to a pre-trained fourth AI model without converting the second image into an RGB image.

According to one or more embodiments, the third AI model and the fourth AI model used for generating the actual normal vector image may be the same or different from each other.

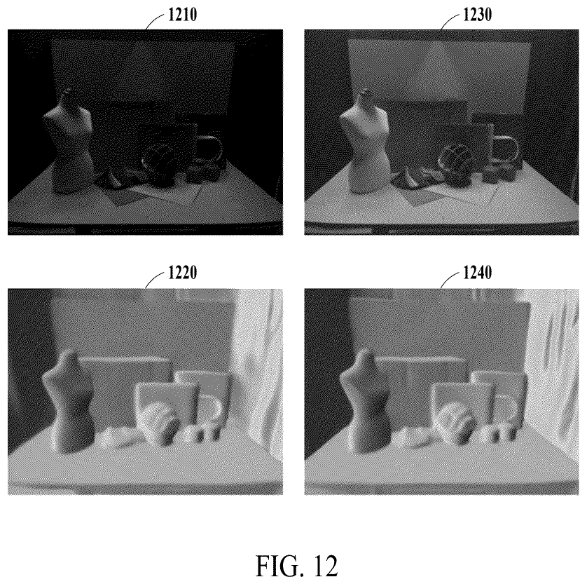

According to one or more embodiments, the processor may generate the actual normal vector image of improved quality by performing gamma correction on the RGB image and inputting the RGB image to an AI model. For example, referring to FIG. 12, by comparing an actual normal vector image 1220 obtained from an RGB image 1210 with an actual normal vector image 1240 obtained from an RGB image 1230 on which gamma correction is performed, it may be identified that an edge of the actual normal vector image 1240 obtained from the RGB image 1230 on which gamma correction is performed is clearer.

According to one or more embodiments, the electronic device of one or more embodiments may obtain a clearer actual normal vector image in the case of a sample image capturing a scene with low brightness by increasing the image brightness by uniformly multiplying a preset coefficient by the RGB image and inputting the RGB image to the AI model.

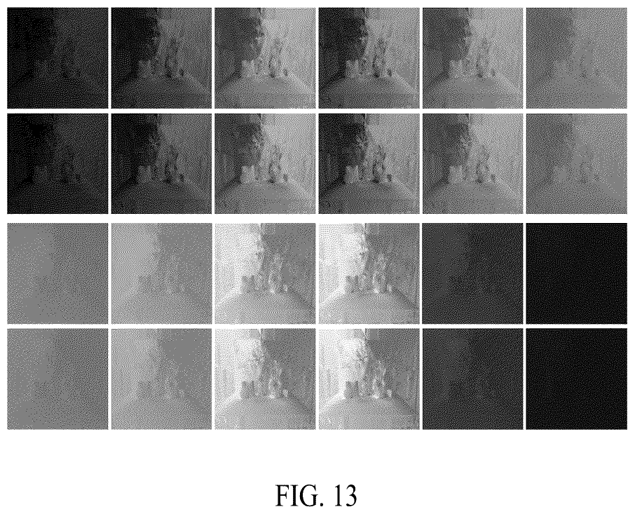

FIG. 13 is a diagram illustrating an experimental result according to one or more embodiments.

According to one or more embodiments, a processor (e.g., the processor 110 of FIG. 1) of an electronic device (e.g., the electronic device of FIG. 1) may evaluate the performance of a first AI model through test data. The test data may be different from the training data and the test data may include a test image collected for an object under a lighting condition and an actual image related to lighting corresponding to the test image.

The processor may measure the performance of the first AI model by determining accuracy evaluation metrics, such as an MSAE of the first AI model by combining an actual image related to lighting included in the test data and a predicted image related to lighting output as the first AI model performs a lighting condition prediction task and may obtain a model optimized to lighting prediction by additionally adjusting the first AI model based on a measurement result.

The effects that may be achieved by the embodiments of the present disclosure are described below with reference to experimental data shown in Table 1 below, for example, and an output image shown in FIG. 13.

TABLE 1

| Work | Method | Test data set | MSAE |
|---|---|---|---|
| RGB image & single lighting | CLCC | NUS-8 | 1.84 |
| RGB image & single lighting | CLCC | Gehler | 1.44 |
| RGB image & multi-lighting | MIMT | LSMI | 2.48 |
| Multispectral image & single | Beyond RGB | Beyond RGB - | 3.18 |
| lighting | | Field | |
| Multispectral image & single | Beyond RGB | Beyond RGB - | 2.26 |
| lighting | | Lab | |
| Multispectral image & multi- | Present | SIRC | 0.94 |
| lighting | disclosure | | |

Table 1 above may show quantitative results of MSAEs in various tasks. The first two rows may be results of RGB images under single-lighting conditions, the third row may be a result of an RGB image under a multi-lighting condition, and the fourth and fifth rows may be results of multispectral images under single-lighting conditions. The last row may be a result of a multispectral image under a multi-lighting condition in one or more embodiments of the present disclosure.

Although the results shown in FIG. 1 are test results in different data sets, an MSAE of the results may show that a color constancy method of a multispectral image under a multi-lighting condition provided by the embodiment of the present disclosure still has high performance.

In one or more embodiments, a contrast method may include contrastive learning for color constancy (CLCC), multi-illuminant color constancy via multi-task local surface and light color learning (MIMT), and beyond RGB (very high resolution urban remote sensing with multimodal deep networks).

In addition, according to one or more embodiments, the related test data set may include NUS-8 Gehler (the most typically used two RGB image single lighting data set), LSMI (a newer, greater, and more natural multi-lighting data set), beyond RGB-Field/Lab (a typically used multispectral image single lighting data set), and SIRC (a multispectral image multi-lighting data set used in the embodiment of the present disclosure).

Some visualization results are shown in FIG. 13. When an output of the first AI model is a 36-channel light map, three of 36 channels may be combined and the three channels may be displayed as an RGB image, and thus, an output of the light map may be converted into 12 RGB images.

The first and third rows of FIG. 13 may be light maps predicted by the first AI model of the embodiment of the present disclosure and the second and fourth rows may be reference data corresponding to GT. As shown in the results, the color and texture of the light map predicted by the first AI model may be significantly close to the reference data and the accuracy may be significantly high.

The electronic devices, processors, memories, communication links, transceivers, image collection devices, display devices, electronic device 100, processor 110, memory 120, communication link 140, transceiver 150, image collection device 160, and display device 170 described herein, including descriptions with respect to respect to FIGS. 1-13, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-13 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors configured to:
collect an original image for a target scene; and
generate a corrected modified image by reflecting a predicted lighting condition of the original image in response to inputting the original image to a first artificial intelligence (AI) model,
wherein the first AI model is generated based on a second AI model trained based on any one or any combination of any two or more of a sample image collected under a plurality of lighting conditions, a first actual image comprising a lighting condition of the sample image, and a second actual image comprising color information of an object in the sample image.

2. The electronic device of claim 1, wherein
the second AI model is trained by:
generating, using the second AI model, a first predicted image comprising the lighting condition information of the sample image and a second predicted image comprising the color information of the object in the sample image through image processing on the sample image
determining a target loss value by comparing the first predicted image with the first actual image and comparing the second predicted image with the second actual image, and
training the second AI module by adjusting a parameter of the second AI model based on the determined target loss value, and
wherein the first AI model is the trained second AI model.

3. The electronic device of claim 1, wherein the first actual image comprises either one or both of a first image in which the lighting condition information of the sample image is visually represented and a second image in which an original color of an object is restored by removing a color bias according to the lighting condition information of the sample image.

4. The electronic device of claim 3, wherein the second actual image comprises a third image generated using either one of:
the second image and a reflectance image generated through color space conversion of the sample image and the first image, wherein the third image characterizes color similarity between pixels of the sample image, and
a fourth image that characterizes a plane direction of the object in the sample image.

5. The electronic device of claim 4, wherein the third image is generated based on a first color similarity between color information of first pixels uniformly selected from one reference image of the reflectance image and the second image and color information of second pixels other than the first pixels in the reference image and second color similarity between color information of third pixels fixed to an object in the reference image and fourth pixels other than the third pixels in the reference image.

6. The electronic device of claim 4, wherein the fourth image is generated through a third AI model that is pre-trained to output a normal vector by receiving one reference image of the second image and a multi-color component image generated by converting the reflectance image.

7. A processor-implemented method comprising:
receiving an original image for a target scene; and
generating a modified image in which a prediction result of lighting condition information of the original image is reflected, in response to inputting the original image to a first artificial intelligence (AI) model,
wherein the first AI model is generated based on a second AI model trained based on any one or any combination of any two or more of a sample image collected under a plurality of pieces of lighting condition information, a first actual image comprising lighting condition information of the sample image, and a second actual image comprising color information of an object in the sample image.

8. The method of claim 7, wherein
the second AI model is trained by:
generating, using the second AI model, a first predicted image comprising the lighting condition information of the sample image and a second predicted image comprising the color information of the object in the sample image through image processing on the sample image;
determining a target loss value by comparing the first predicted image with the first actual image and comparing the second predicted image with the second actual image, and
training the second AI module by adjusting a parameter of the second AI model based on the determined target loss value, and
wherein the first AI model is the trained second AI model.

9. The method of claim 7, wherein the first actual image comprises either one or both of a first image in which the lighting condition information of the sample image is visually represented and a second image in which an original color of an object is restored by removing a color bias according to the lighting condition information of the sample image.

10. The method of claim 9, wherein the second actual image comprises a third image generated using either one of:
the second image and a reflectance image generated through color space conversion of the sample image and the first image, wherein the third image characterizes color similarity between pixels of the sample image, and
a fourth image that characterizes a plane direction of the object in the sample image.

11. The method of claim 10, wherein the third image is generated based on a first color similarity between color information of first pixels uniformly selected from one reference image of the reflectance image and the second image and color information of second pixels other than the first pixels in the reference image and second color similarity between color information of third pixels fixed to an object in the reference image and fourth pixels other than the third pixels in the reference image.

12. The method of claim 10, wherein the fourth image is generated through a third AI model that is pre-trained to output a normal vector by receiving one reference image of the second image and a multi-color component image generated by converting the reflectance image.

13. A non-transitory computer-readable storage medium storing instructions that, when executed by one or more processors, configure the one or more processors to perform the method of claim 7.

14. A processor-implemented method comprising:
generating a first predicted image comprising lighting condition information of a sample image and a second predicted image comprising color information of an object in the sample image, in response to inputting the sample image comprised in training data to a second artificial intelligence (AI) model;
determining a target loss value by comparing the first predicted image with a first actual image and comparing the second predicted image with a second actual image comprised in the training data;
adjusting a parameter of the second AI model by training the parameter of the second AI model based on the determined target loss value; and
generating a first AI model for outputting a corrected modified image by reflecting a predicted lighting condition of an original image based on the second AI model of which the parameter is adjusted.

15. The method of claim 14, wherein the first actual image comprises either one or both of a first image in which the lighting condition information of the sample image is visually represented and a second image in which an original color of an object is restored by removing a color bias according to the lighting condition information of the sample image.

16. The method of claim 15, wherein the second actual image comprises a third image generated using either one of:
the second image and a reflectance image generated through color space conversion of the sample image and the first image, wherein the third image characterizes color similarity between pixels of the sample image, and
a fourth image that characterizes a plane direction of the object in the sample image.

17. The method of claim 16, wherein the reflectance image is generated by performing lighting information from a first XYZ image generated by performing color space conversion on the sample image, based on a second XYZ image generated by performing color space conversion on the first image.

18. The method of claim 16, wherein the reflectance image is generated by, in response to the sample image being a multi-lighting image captured under a multi-lighting condition,
generating a third XYZ image by performing color space conversion on a single lighting image captured under a single lighting condition for a same scene as the multi-lighting image;
generating a fourth XYZ image by performing color space conversion on a first image corresponding to the single lighting image;
determining XYZ reflectance for the single lighting image by removing lighting information from the third XYZ image based on the fourth XYZ image; and
aggregating and normalizing XYZ reflectances for single lighting images according to the multi-lighting condition to generate the reflectance image.

19. The method of claim 16, wherein the third image is generated based on a first color similarity between color information of first pixels uniformly selected from one reference image of the reflectance image and the second image and color information of remaining pixels other than the first pixels in the reference image and second color similarity between color information of second pixels fixed to an object in the reference image and remaining pixels other than the second pixels in the reference image.

20. The method of claim 16, wherein the fourth image is generated through a third AI model that is pre-trained to output a normal vector by receiving one reference image of the second image and a multi-color component image generated by converting the reflectance image.
